(19) United States
(12) Patent Application Publication
(10) Pub. No.: US 2026/0124757 A1
(43) Pub. Date: May 7, 2026

(54) PLANNING METHODS FOR EMBODIED INTERACTION OF INTELLIGENT AGENTS BASED ON ACTIVE PERCEPTION OF ENVIRONMENTAL INFORMATION

(71) Applicant: TONGJI UNIVERSITY, Shanghai (CN)

(72) Inventors: Bin HE, Shanghai (CN); Runjie SHEN, Shanghai (CN); Chengjin WANG, Shanghai (CN); Yanmin ZHOU, Shanghai (CN); Feng LUAN, Shanghai (CN); Zhipeng WANG, Shanghai (CN)

(73) Assignee: TONGJI UNIVERSITY, Shanghai (CN)

(21) Appl. No.: 19/346,389

(22) Filed: Sep. 30, 2025

(30) Foreign Application Priority Data
Sep. 30, 2024 (CN) 202411378786.0

(51) Int. Cl. B25J 9/16; B25J 13/08; G06V 10/20; G06V 10/80

(52) U.S. Cl. CPC B25J 9/1694; B25J 9/1661; B25J 13/085; G06V 10/255; G06V 10/811

(57) ABSTRACT

Provided is a method for planning embodied interaction of an intelligent agent based on active perception of environmental information. The method includes: obtaining aligned environmental information and aligned interaction information; obtaining semantic feature information, an operating environment of the intelligent agent, and an interaction characteristic parameter based on the aligned environmental information and the aligned interaction information; performing multi-modal information fusion and representation on the semantic feature information, the operating environment of the intelligent agent, and the interaction characteristic parameter to obtain multi-dimensional environment information; performing a predictability judgment on a robot action based on an embodied interaction perception signal; in response to a judgment result being within an expectation, generating a plurality of first interaction actions based on the multi-dimensional environment information and a planning task step, and transmitting the plurality of first interaction actions to a robot for execution; and in response to the judgment result being outside the expectation, generating a plurality of second interaction actions based on the interaction characteristic parameter, and transmitting the plurality of second interaction actions to the robot for execution.

### CROSS-REFERENCE TO RELATED APPLICATIONS

This application claims priority of Chinese Patent Application No. 202411378786.0, filed on Sep. 30, 2024, the contents of which are incorporated herein by reference.

### TECHNICAL FIELD

The present disclosure generally relates to a field of collaborative intelligent agent embodied intelligence, and in particular to a method for planning embodied interaction of an intelligent agent based on active perception of environmental information.

### BACKGROUND

In recent years, with the significant improvement in the depth and breadth of applications in the intelligent agent industry, the application scenarios have gradually moved from factories into communities, and intelligent agents have started to operate in scenarios where the intelligent agents coexist with humans. The types of operating scenarios, characterized by unknowns, complexity, density, and human habitation, involve a large number of interactive operation tasks. The types of operating scenarios will impose higher requirements on the adaptability of interaction actions during the operation of the intelligent agents. During an application process, the intelligent agent needs to consider not only task completion and movement stability but also prioritize motion safety. Ensuring the adaptability and safety of actions in the operating scenario is a prerequisite for the application of the service intelligent agent. Currently, vision-based passive unimodal environmental perception and representation manners often fail to meet the requirements of motion planning constraints and the interpretability of embodied interactions of the intelligent agents, as the manners overlook the perception of implicit physical properties closely related to embodied interactions. The overlooking leads to uncoordinated or even motion failure situations during the operation of the intelligent agents in such scenarios.

Currently, a primary solution for action planning of the intelligent agents in such scenarios is to store interaction properties of objects as prior knowledge in the latent space of a neural network. Through visual observation, a trained neural network is used to infer manipulation properties of the objects, which are represented in semantic form to constrain the embodied interaction actions of the intelligent agents.

However, a main problem with such solutions is the lack of predictability regarding the results of the interaction actions, often leading to unexpected motion failures. The intelligent agents struggle to comprehend temporal features of interaction force-response of the objects during embodied interaction, and thus the intelligent agents cannot predict an expected result of the interaction action, which increases the risk of instability in the interaction actions of the intelligent agent, and make the safety of the robot interaction action not be fully guaranteed.

### SUMMARY

One or more embodiments of the present disclosure provide a method for planning embodied interaction of an intelligent agent based on active perception of environmental information. The method includes: obtaining environmental information around the intelligent agent and interaction information at an interaction interface between the intelligent agent and an object, the interaction information being an embodied interaction perception signal, and the environmental information including a two-dimensional image and depth; extracting sampling data of a most recent time from the environmental information and the interaction information, and aligning the sampling data to obtain aligned environmental information and aligned interaction information; performing object recognition and semantic segmentation on the aligned environmental information to obtain semantic feature information, and fusing the aligned environmental information to obtain an operating environment of the intelligent agent; inferring an interaction characteristic parameter based on the aligned interaction information; performing multi-modal information fusion and representation on the semantic feature information, the operating environment of the intelligent agent, and the interaction characteristic parameter to obtain multi-dimensional environment information; performing a predictability judgment on a robot action based on the embodied interaction perception signal; in response to a judgment result being within an expectation, generating a plurality of first interaction actions based on the multi-dimensional environment information and a planning task step, and transmitting the plurality of first interaction actions to the robot for execution; and in response to the judgment result being outside the expectation, generating a plurality of second interaction actions based on the interaction characteristic parameter, and transmitting the plurality of second interaction actions to the robot for execution, the plurality of second interaction actions having an interaction force characteristic.

One or more embodiments of the present disclosure provide a system for planning embodied interaction of an intelligent agent based on active perception of environmental information. The system includes: at least one storage medium including a set of instructions; and at least one processor in communication with the at least one storage medium. When the set of instructions is executed, the at least one processor is configured to cause the system to perform operations. The operations include: obtaining environmental information around the intelligent agent and interaction information at an interaction interface between the intelligent agent and an object, the interaction information being an embodied interaction perception signal, and the environmental information including a two-dimensional image and depth; extracting sampling data of a most recent time from the environmental information and the interaction information, and aligning the sampling data to obtain aligned environmental information and aligned interaction information; performing object recognition and semantic segmentation on the aligned environmental information to obtain semantic feature information, and fusing the aligned environmental information to obtain an operating environment of the intelligent agent; inferring an interaction characteristic parameter based on the aligned interaction information; performing multi-modal information fusion and representation on the semantic feature information, the operating environment of the intelligent agent, and the interaction characteristic parameter to obtain multi-dimensional environment information; performing a predictability judgment on a robot action based on the embodied interaction perception signal; in response to a judgment result being within an expectation, generating a plurality of first interaction actions based on the multi-dimensional environment information and a planning task step, and transmitting the plurality of first interaction actions to the robot for execution; and in response to the judgment result being outside the expectation, generating a plurality of second interaction actions based on the interaction characteristic parameter, and transmitting the plurality of second interaction actions to the robot for execution, the plurality of second interaction actions having an interaction force characteristic.

One or more embodiments of the present disclosure provide a non-transitory computer-readable storage medium. The storage medium stores computer instructions. When the computer instructions are executed by a processor, the processor implement a method for planning embodied interaction of an intelligent agent based on active perception of environmental information.

### BRIEF DESCRIPTION OF THE DRAWINGS

The present disclosure is further described by way of exemplary embodiments. These exemplary embodiments are described in detail with reference to the accompanying drawings. These embodiments are not limiting. In these embodiments, the same reference numerals denote the same structures.

FIG. 1 is an exemplary block diagram illustrating a multi-modal perception system according to some embodiments of the present disclosure;

FIG. 2 is a flowchart illustrating a multi-modal perception process according to some embodiments of the present disclosure;

FIG. 3 is a flowchart illustrating a process for inferring environmental information according to some embodiments of the present disclosure;

FIG. 4 is a flowchart illustrating a process for generating an embodied interaction planning action according to some embodiments of the present disclosure;

FIG. 5 is an exemplary flowchart illustrating a method for planning embodied interaction of an intelligent agent based on active perception of environmental information according to some embodiments of the present disclosure;

FIG. 6 is a schematic diagram illustrating a process for inferring an interaction characteristic parameter according to some embodiments of the present disclosure;

FIG. 7 is an exemplary flowchart illustrating a process for performing a predictability judgment on a robot action according to some embodiments of the present disclosure; and

FIG. 8 is an exemplary flowchart illustrating a process for generating a plurality of first interaction actions according to some embodiments of the present disclosure.

### DETAILED DESCRIPTION

The present disclosure is described in detail below with reference to the accompanying drawings and specific embodiments. The embodiment is implemented on the premise of the technical solution of the present disclosure, and provides a detailed implementation manner and a specific operation process. However, the protection scope of the present disclosure is not limited to the following embodiments.

An embodiment of the present disclosure provides a method for planning embodied interaction of an intelligent agent based on active perception of environmental information.

An embodiment of the present disclosure provides a system for planning embodied interaction of an intelligent agent based on active perception of environmental information. The system includes: at least one storage medium including a set of instructions; and at least one processor in communication with the at least one storage medium. When the set of instructions is executed, the at least one processor instructs the system to perform the method for planning embodied interaction of an intelligent agent based on active perception of environmental information.

As one implementation of the aforementioned system, a multi-modal perception system enables the method for planning embodied interaction of an intelligent agent based on active perception of environmental information.

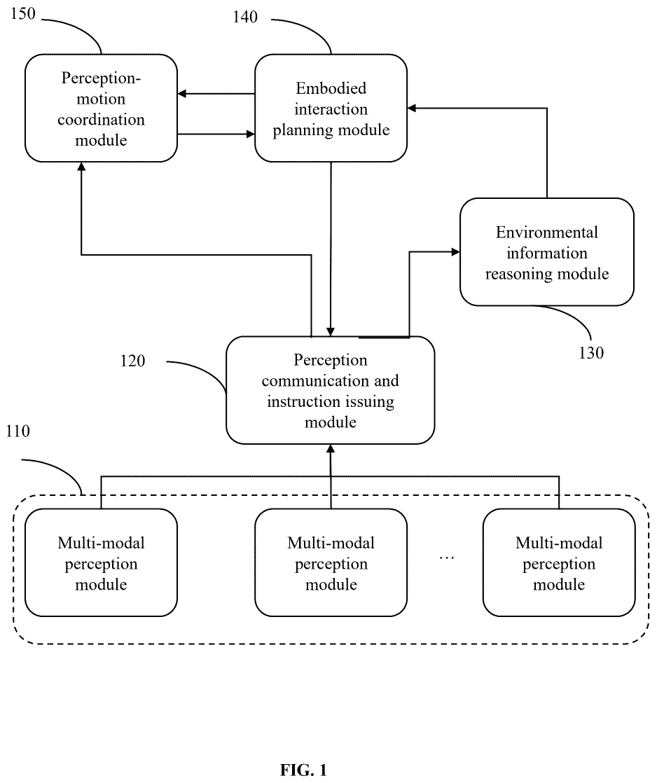

FIG. 1 is an exemplary block diagram illustrating a multi-modal perception system according to some embodiments of the present disclosure.

As shown in FIG. 1, the multi-modal perception system 100 includes a multi-modal perception module 110, a perception communication and instruction issuing module 120, an environmental information reasoning module 130, an embodied interaction planning module 140, and a perception-motion coordination module 150.

The multi-modal perception module 110 is configured to effectively collect local operational environment information of the intelligent agent to meet requirements of environment perception for an embodied intelligent agent and constraints for motion planning of the intelligent agent.

The intelligent agent refers to a brain or a decision-making system that controls a robot entity. The embodied intelligent agent refers to an intelligent agent that has a physical body.

The local operational environment information refers to dynamic data of a part of an environment within a direct operating range of the intelligent agent and closely related to a current task. In some embodiments, the local operational environment information is also referred to as environmental information.

The motion planning of the intelligent agent refers to a process of determining a safe, collision-free motion path or trajectory from a start state to a target state that satisfies dynamic constraints for the intelligent agent.

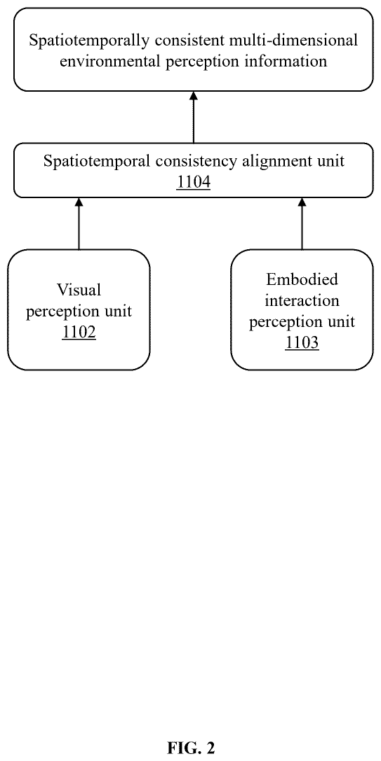

FIG. 2 is a flowchart illustrating a multi-modal perception process according to some embodiments of the present disclosure.

In some embodiments, as shown in FIG. 2, the multi-modal perception module 110 includes a visual perception unit 1102 (e.g., a red, green, blue-depth (RGB-D) visual perception unit), an embodied interaction perception unit 1103, and a spatiotemporal consistency alignment unit 1104. The visual perception unit 1102 is configured to perform geometric and image perception of a surrounding environment of the embodied intelligent agent to achieve large-scale rapid spatial recognition and mapping. The embodied interaction perception unit 1103 is configured to collect an object signal at an interaction interface, observe a spatial state response of an object after stimulation, and complete pairing of temporal signals of interaction force-response. The spatiotemporal consistency alignment unit 1104 is configured to perform temporal alignment on data collected by a plurality of types of perception devices, complete spatiotemporal consistency calibration, and transmit a unified observation signal to the environmental information reasoning module 130 via the perception communication and instruction issuing module.

The spatial state response refers to a change in position, orientation, or shape of the object or at the interaction interface, resulting from a force applied to the object by the intelligent agent.

The object refers to a target operated by a robot, e.g., a cup gripped by the robot.

The interaction force refers to a force applied by the intelligent agent to the environment (or the object). The interaction response temporal signal refers to data of a spatial state (e.g., a displacement) fed back by the environment changing over time.

The temporal alignment refers to a technique used to resolve time differences caused by different sampling frequencies and collection times of different sensors.

The spatiotemporal consistency calibration refers to a comprehensive calibration process including temporal alignment and spatial alignment.

The unified observation signal is aligned interaction information.

In some embodiments, a specific implementation of the multi-modal perception module 110 is as follows.

The RGB-D visual perception unit 1102 collects temporal signals of the environmental information around the intelligent agent in a form of a two-dimensional image and depth. The collected visual data is then timestamped and stored in corresponding queues.

The depth refers to distance information between each pixel point and a camera. The collected visual data includes the two-dimensional image and the depth.

The embodied interaction perception unit 1103 is configured to collect information at the interaction interface between the intelligent agent and the object. The collection includes: performing temporal collection of an interaction force stimulus during an interaction process, a response displacement of the object, a temperature, a vibration signal, etc. The collected multi-dimensional data is then timestamped and stored in corresponding queues in a dictionary form.

The information at the interaction interface between the intelligent agent and the object refers to all physical quantities generated and measured in a contact region at an instant and during a process when the robot physically contacts the object. In some embodiments, the information at the interaction interface between the intelligent agent and the object may also be referred to as interaction information.

The interaction process refers to a series of events where continuous and dynamic physical contact occurs between the intelligent agent and an external environment (the object), accompanied by exchange of energy, information, and momentum.

The interaction force stimulus refers to a force or torque actively applied by the intelligent agent to the object. The interaction force stimulus may be obtained via a force sensor, a torque sensor, or the like.

The response displacement refers to motion generated by the object under the interaction force stimulus applied by the intelligent agent. The response displacement may be obtained via an encoder, a vision system, or the like.

The temperature refers to a temperature change at the interaction interface. The temperature may be obtained via a temperature sensor, a thermal imaging camera, or the like.

The vibration signal refers to a high-frequency, small-amplitude mechanical vibration generated by contact during an interaction process between the robot and the environment. The vibration signal may be obtained via an accelerometer, a high-frequency tactile sensor, or the like.

The collected multi-dimensional data is the interaction information.

The spatiotemporal consistency alignment unit 1104 extracts sampling data of a most recent time from the data storage queue of the RGB-D visual perception unit 1102 and the data storage queue of the embodied interaction perception unit 1103 according to a specific sampling frequency. The sampling data is then aligned in a time dimension using a reference sensor alignment manner, and the aligned data is transmitted to the perception communication and instruction issuing module 120.

The specific sampling frequency refers to a set count of times of extracting the sampling data per unit time.

The sampling data of the most recent time refers to the latest set of sensor readings in time extracted from a continuous data stream. The reference sensor refers to a sensor serving as a reference standard.

The alignment refers to a process of unifying timestamps of different sensor data to ensure that the different sensor data reflect an environmental state at a same moment.

The aligned data includes aligned environmental information and aligned interaction information.

Considering a spatial consistency problem of distributed perception of the embodied interaction perception unit 1103, a spatial position of each embodied interaction perception device is determined based on a forward kinematics chain manner by obtaining joint position encoding information of the robot.

The forward kinematics chain manner refers to a manner for determining a position and an orientation of an end effector of the robot in a three-dimensional space based on known joint position encoding information and a geometric model of the robot.

The end effector refers to an operation unit installed at an end of a robotic arm of the robot. The end effector includes a gripper, a suction device, a push rod, or the like.

The joint position encoding information refers to measurement data from a joint encoder of the robot. The joint encoder refers to a sensor installed on each joint motor and configured to measure a rotation angle or a linear displacement of each joint. The joint refers to each movable connection point on the robotic arm of the robot.

The embodied interaction perception device refers to a multi-modal perception element configured to collect physical feedback signals during the interaction process, e.g., a force sensor, a displacement sensor, a vibration sensor, a temperature sensor, or the like. In some embodiments, the embodied interaction perception device may also be referred to as a perception device.

The spatial position of the embodied interaction perception device may be determined by the following formula (1):

$${P}_{i} = {}_{i}^{w} {Tp}_{i} , \qquad ( 1 )$$

wherein Pᵢ denotes a position of an i-th perception device relative to a centroid coordinate system of the robot, pᵢ denotes a position of the i-th perception device relative to a Cartesian space of a parent joint, and

$${}_{i}^{w} T$$

denoted a Homogeneous transformation matrix of the parent joint corresponding to the perception device relative to the centroid coordinate system of the robot.

The centroid coordinate system refers to a reference coordinate system established with a centroid (center of gravity) of the robot as an origin.

The parent joint refers to a joint that directly drives or connects a corresponding perception device.

The Cartesian space refers to a geometric space defined by one or more mutually perpendicular coordinate axes.

The homogeneous transformation matrix refers to a matrix used to describe a pose of one coordinate system with respect to another.

The perception communication and instruction issuing module 120 is configured to be responsible for information acquisition and transmission of distributed multi-mode perception devices and the transmitting of motion control instructions of the intelligent agent.

The distributed multi-mode perception devices refer to combinations of sensor units integrating a plurality of types of sensors dispersed throughout body of the robot.

The environmental information reasoning module 130 is configured to perform perception data processing on the environmental information collected by the multi-modal perception module to achieve environment modeling and environmental interaction characteristic inference of the embodied intelligent agent.

The environment modeling refers to construction of an internal digital representation or virtual map of an external world within the intelligent agent based on perception data.

The environmental interaction characteristic refers to a dynamic mechanical response and a behavioral pattern exhibited by the environment (including objects and surfaces within the environment) when it comes into physical contact and interaction with the intelligent agent.

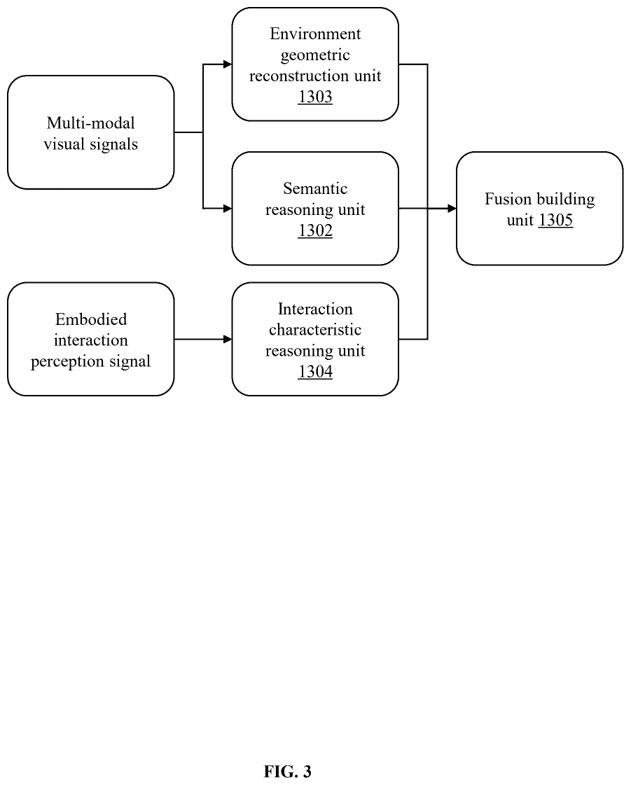

FIG. 3 is a flowchart illustrating a process for inferring environmental information according to some embodiments of the present disclosure.

In some embodiments, as shown in FIG. 3, the environmental information reasoning module 130 includes a semantic reasoning unit 1302, an environment geometric reconstruction unit 1303, an interaction characteristic reasoning unit 1304, and a fusion building unit 1305. The semantic reasoning unit 1302 is configured to reason about semantic information of the environment to accomplish identification of semantic attributes of the objects in the environment. The environment geometric reconstruction unit 1303 is configured to model information about the environment surrounding the intelligent agent based on geometric information and phenological information of multi-modal environment perception to realize reconstruction of a three-dimensional geometric map. The interaction characteristic reasoning unit 1304 is configured to make sense of the temporal signals of interaction force-response collected by embodied interaction perception, and to accomplish implicit characteristic inference of the objects that are difficult to observe visually and are closely related to embodied interaction properties. The fusion building unit 1305 is configured to fuse a constructed three-dimensional map, a semantic map, and an inferred object interaction feature to build a multi-dimensional environmental information map.

The semantic information refers abstract meaning, functional categories, and logical relationships of objects and scenes within the environment. The semantic attributes refer to labels or keywords that are attached to an object and describe static characteristics of the object.

The geometric information refers to data that describes purely physical shape, size, position, and spatial relationships of objects and structures in the environment. The phenological information refers to data related to visual appearance characteristics of a surface of an object, e.g., color, texture, brightness, etc.

The three-dimensional map represents the operating environment of the intelligent agent, the semantic map represents semantic feature information, the object interaction feature represents an interaction characteristic parameter, and the multi-dimensional environment information map represents multi-dimensional environment information.

In some embodiments, a specific implementation of the environmental information reasoning module 130 is as follows.

The semantic reasoning unit 1302, based on convolutional neural network technology, realizes semantic feature reasoning of the object by performing object recognition and semantic segmentation on a collected image, and subsequently fusing segmented semantic features with an object model completed by the reconstruction of the environment geometric reconstruction unit 1303.

The object recognition refers to a process of identifying objects in an image and labeling positions and categories of the objects with bounding boxes. The object recognition may be realized by Fast Region-based Convolutional Neural Network (Fast R-CNN), Mask Region-based Convolutional Neural Network (Mask R-CNN), or the like.

The semantic segmentation refers to a process of classifying pixels in an image. The semantic segmentation may be realized by Fully Convolutional Network (FCN), U-Shaped Network (U-Net), or the like.

The environment geometric reconstruction unit 1303 fuses a collected RGB image and depth point cloud information based on three-dimensional reconstruction techniques (Neural Radiance Fields (Nerf), Gaussian sputtering surfaces, etc.) to perceive the geometric information of the environment of the intelligent agent, and completes the geometric reconstruction of the operating environment of the intelligent agent.

The interaction characteristic reasoning unit 1304 uses a data-driven system identification manner to complete an implicit feature parameter inference of an object that is closely related to the interaction characteristic based on the temporal features of interaction force-response collected by the embodied interaction perception unit 1103.

The fusion building unit 1305 performs environmental information fusion mapping based on the semantic feature information extracted by the semantic reasoning unit 1302, the environment geometric information reconstructed by the environment geometric reconstruction unit 1303, and the interaction characteristic parameter inferred by the interaction characteristic reasoning unit 1304, by adopting a manner of multi-modal information fusion and representation. The resulting multi-dimensional environment information is used for action generation in the embodied interaction planning module 140.

The semantic feature information refers to category information of an object obtained after processing by techniques such as the object recognition and the semantic segmentation. The semantic feature information may be used to determine material properties, functional types, or structural features of interacting objects, etc.

The environment geometric information refers to data used to describe physical structures of objects and structures in the environment in terms of three-dimensional shape, position, and volume. In some embodiments, the environment geometric information may also be referred to as the operating environment of the intelligent agent.

The multi-modal information fusion refers to a process for combining three types of information with different sources and structures, namely the semantic feature information, the operating environment of the intelligent agent, and the interaction characteristic parameter, to form a unified form of representation that is used for interaction action generation.

The multi-dimensional environment information refers to the final and most comprehensive environmental information obtained after multi-modal information fusion.

The embodied interaction planning module 140 is configured to generate an embodied interaction motion sequence to realize active perception and ultimately complete an interaction operation based on an operation task of the intelligent agent and environment perception reasoning constraints.

The operation task of the intelligent agent refers to a corresponding task that the intelligent agent needs to control the robot to accomplish.

The environment perception reasoning constraints refer to environmental information provided by the environmental information reasoning module 130 that poses a limitation on planning. The environment perception reasoning constraints include environment modeling of the embodied intelligent agent and the environment interaction characteristic.

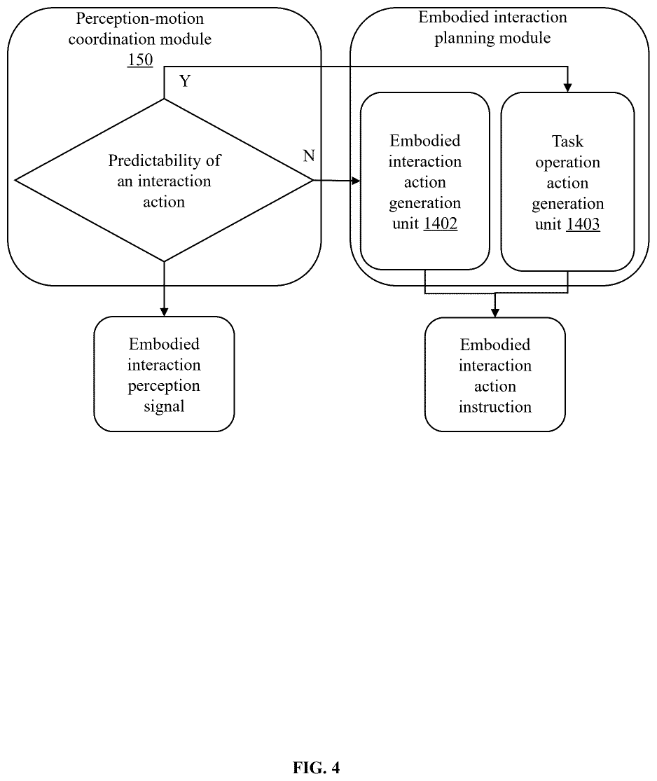

FIG. 4 is a flowchart illustrating a process for generating an embodied interaction planning action according to some embodiments of the present disclosure.

In some embodiments, the embodied interaction planning module 140 includes an embodied interaction action generation unit 1402 and a task operation action generation unit 1403. The embodied interaction action generation unit 1402 is configured to generate a plurality of embodied interaction instructions to control the intelligent agent to apply a plurality of interaction actions to an object to be interacted with, and complete collection of the temporal features of interaction force-response. The task operation action generation unit 1403 is configured to generate a plurality of intelligent agent operation actions with predictable interaction properties based on environmental information constraints and a task instruction of the intelligent agent. In some embodiments, a specific implementation of the embodied interaction planning module 140 is as follows.

To ensure coordination and consistency between the embodied interaction action generation unit 1402 and the task operation action generation unit 1403, the perception-motion coordination module 150 first perceives the environment by utilizing the multi-modal perception module 110, and uses a judgment result to activate a corresponding embodied interaction action generation unit. When an action of the intelligent agent is within a predictable range, the task operation action generation unit 1403 is activated. Otherwise, the embodied interaction action generation unit 1402 is activated.

The embodied interaction action generation unit 1402 is configured to utilize the interaction characteristic parameters of an object inferred by the interaction characteristic reasoning unit 1304 and generate a plurality of interaction actions with interaction force characteristics based on an energy gradient manner, which guides the intelligent agent to apply force stimuli to the object, after which the embodied interaction perception unit 1103 perceives the interaction characteristic information of the object.

The energy gradient manner is a mathematical framework based on optimization theory. For example, the energy gradient manner includes a gradient descent manner, a Newton manner, etc.

The interaction force characteristics refer to mechanical behavior traits presented by the end effector or a body part of the robot when the robot makes physical contact with the environment (including a human, an object). In some embodiments, each interaction action with the interaction force characteristic may also be referred to as a second interaction action.

The task operation action generation unit 1403 is configured to, for task execution of the intelligent agent in a complex scene, generate a plurality of embodied interaction actions based on a multi-modal information map generated by the environmental information reasoning module 130 and a planned specific task step, through the energy gradient manner, which overcome amotion stability problem of the intelligent agent caused by an unknown, complex, dense, and human-inhabited characteristic operation scene through changes in spatial states of the intelligent agent itself and a surrounding environment.

In some embodiments, the multi-modal information map may also be referred to as the multi-dimensional environment information.

The planned specific task step refers to a target tracking point sequence and a path planning action sequence generated in the operating environment of the intelligent agent based on a current interaction task target. The planned specific task step includes a spatial position of an object, an expected operation type (e.g., gripping, pushing), a task completion sequence, etc. In some embodiments, the planned specific task step may also be referred to as a planning task step.

The embodied interaction actions refer to actions in which a robot uses its own body morphology, sensor feedback, and internal models to actively perceive and understand the environment through real-time, dynamic physical interaction with the environment, ultimately achieving goals. In some embodiments, each embodied interaction action may also be referred to as a first interaction action.

The perception-motion coordination module 150 is configured to determine predictability of the embodied interaction actions of a current intelligent agent, and coordinate and activate a corresponding active interaction perception and task operation planning unit in the embodied interaction planning module.

The predictability refers to a degree to which an action currently being executed or to be executed by a robot is easily understood and predicted by an external observer (or the robot itself).

The active interaction perception refers to a strategy of using an action as a means to enhance perception.

The task operation planning unit refers to a unit responsible for generating a specific action sequence for completing a target task (e.g., “grab a water cup”).

In some embodiments, the multi-modal perception module 110 may perceive multi-dimensional information interaction about the environment and the interaction between the intelligent agent and the environment, and then transmit perceived data to the environmental information reasoning module 130 and the perception-motion coordination module 150 via the perception communication and instruction issuing module 120 after spatiotemporal consistency calibration to meet a need for embodied action generation of the intelligent agent.

The perception communication and instruction issuing module 120 is responsible for a data path of an entire body of the intelligent agent, transmits the multi-modal perception module 110 to a unit that needs to subscribe, and sends an action instruction generated by the embodied interaction planning module 140 to a joint module to complete an embodied action.

The environmental information reasoning module 130 performs fusion and mapping of the collected environmental information, provides an environmental constraint for action generation for the embodied interaction planning module 140, and ensures predictability of the action of the intelligent agent.

The embodied interaction planning module 140 drives the robot to generate the embodied interaction action according to a task planning requirement, an environmental information constraint fused by the environmental information reasoning module 130, and the action generation unit activated by the perception-motion coordination module 150.

The perception-motion coordination module 150 evaluates the predictability of the interaction action of the intelligent agent based on an information feature at the interaction interface collected by the multi-modal perception module 110, and based on an evaluation result, activates a corresponding action generation unit in the embodied interaction planning module 140 to generate the action instruction.

In some embodiments, the multi-modal perception system 100 further includes a processor (not shown in the figure). The processor may process at least one of data or information obtained from other devices or system components. The processor may execute program instructions based on at least one of the data, the information, or a processing result to perform one or more functions described in the present application. In some embodiments, the processor may include one or more sub-processing devices (e.g., a single-core processing device or a multi-core multi-chip processing device). Merely by way of example, the processor 120 may include a central processing unit (CPU), an application specific integrated circuit (ASIC), an application specific instruction processor (ASIP), a graphics processing unit (GPU), a physics processing unit (PPU), a digital signal processor (DSP), a field programmable gate array (FPGA), a programmable logic device (PLD), a controller, a microcontroller unit, a reduced instruction set computer (RISC), a microprocessor, or any combination thereof.

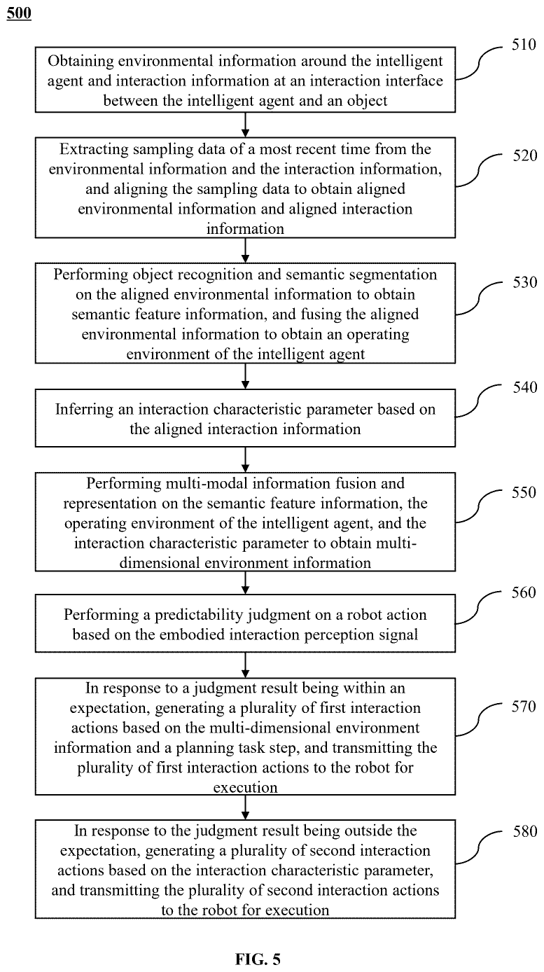

In some embodiments, the multi-modal perception module 110, the perception communication and instruction issuing module 120, the environmental information reasoning module 130, the embodied interaction planning module 140, and the perception-motion coordination module 150 may be partially or entirely integrated in the processor. More details regarding the processor executing the method for planning embodied interaction of an intelligent agent based on active perception of environmental information may be found in other contents of the present disclosure (e.g., descriptions in connection with FIG. 5 to FIG. 8).

FIG. 5 is an exemplary flowchart illustrating a method for planning embodied interaction of an intelligent agent based on active perception of environmental information according to some embodiments of the present disclosure. As shown in FIG. 5, a process 500 includes operation 510 to operation 580. The process 500 may be executed by a processor.

In 510, environmental information around the intelligent agent and interaction information at an interaction interface between the intelligent agent and an object may be obtained.

Surroundings refer to an action space where the intelligent agent performs an interaction operation. For example, for a robotic arm, the surroundings refer to a range that is covered by an arm span of the robotic arm.

In some embodiments, the environmental information includes a two-dimensional (2D) image and depth. The environmental information may be obtained through an optical camera, a lidar, etc. The interaction interface between the intelligent agent and the object refers to a critical region or point where a robot makes physical contact with an object to be operated.

In some embodiments, the interaction information is an embodied interaction perception signal. The embodied interaction perception signal refers to a collection of data such as weight, vibration, etc. generated during an interaction process.

More details regarding the intelligent agent, the environmental information, the object, the interaction interface, and the interaction information may be found in other contents of the present disclosure (e.g., descriptions in connection with FIG. 1).

In some embodiments, the interaction information includes an interaction force stimulus during the interaction process, a response displacement of the object, a temperature, and a vibration signal, and the embodied interaction perception signal is obtained based on a perception device. More details regarding the interaction process, the interaction force stimulus, the response displacement, the temperature, the vibration signal, etc., may be found in other contents of the present disclosure (e.g., descriptions in connection with FIG. 2).

In some embodiments, a spatial position of the perception device is obtained through coordinate transformation based on a position of a Cartesian space of the perception device relative to a parent joint and via a homogeneous transformation matrix of the parent joint corresponding to the perception device relative to a centroid coordinate system of the robot.

Exemplarily, the spatial position of the perception device is obtained by the above formula (1).

More details regarding the parent joint, the position of the Cartesian space, the centroid coordinate system, and the homogeneous transformation matrix may be found in other contents of the present disclosure (e.g., descriptions in connection with FIG. 1).

Through coordinate transformation, the spatial position of the perception device can be accurately located, which facilitates global unified environmental perception for the robot and ensures consistency between perception and motion of the intelligent agent.

The interaction information is obtained through the perception device, enabling the intelligent agent to safely and reliably physically interact with the environment and autonomously and intelligently adapt to unknown and unstructured environments.

In 520, sampling data of a most recent time may be extracted from the environmental information and the interaction information, and the sampling data may be aligned to obtain aligned environmental information and aligned interaction information. More details regarding the sampling data of the most recent time and the alignment may be found in other contents of the present disclosure (e.g., descriptions in connection with FIG. 2).

In some embodiments, after obtaining the sampling data of the most recent time, the processor aligns the sampling data in a plurality of ways. An exemplary alignment manner includes a manner aligned with a reference sensor, nearest point matching, etc.

In 530, object recognition and semantic segmentation may be performed on the aligned environmental information to obtain semantic feature information, and the aligned environmental information may be fused to obtain an operating environment of the intelligent agent. More details regarding the object recognition, the semantic segmentation, the semantic feature information, and the operating environment of the intelligent agent may be found in other contents of the present disclosure (e.g., descriptions in connection with FIG. 3).

Fusion refers to a process of generating a three-dimensional environment model by fusing the two-dimensional image and the depth.

In some embodiments, the aligned environmental information is fused in a plurality of ways, such as, map-based fusion, multi-sensor fusion, etc. The map-based fusion refers to projecting results of the recognition and the segmentation onto a map. The multi-sensor fusion refers to fusing the results of the recognition and the segmentation of the aligned environmental information at a data level.

In 540, an interaction characteristic parameter may be inferred based on the aligned interaction information.

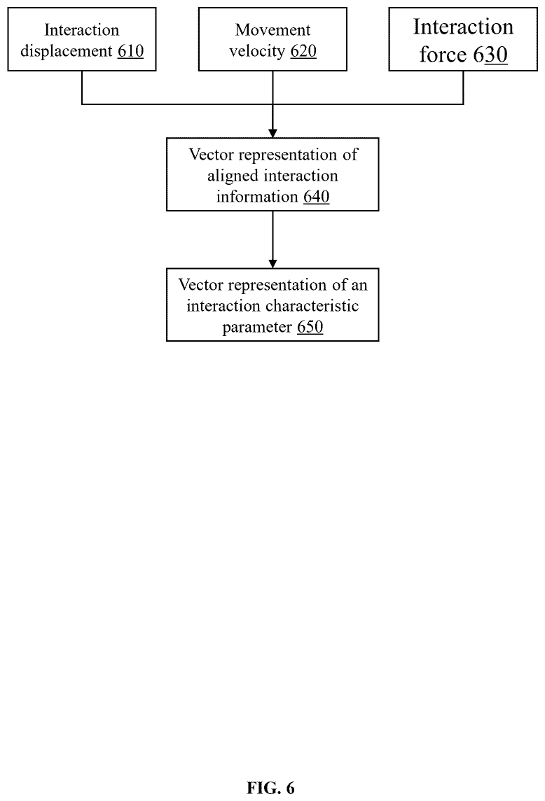

The interaction characteristic parameter refers to a parameter for describing a mechanical response characteristic of the object during an embodied interaction process. For example, the interaction characteristic parameter includes an elastic operation coefficient of the object, a damping operation coefficient of the object, an operation loss constant of the object, etc. More details regarding the elastic operation coefficient of the object, the damping operation coefficient of the object, and the operation loss constant of the object may be found in other contents of the present disclosure (e.g., descriptions in connection with FIG. 6).

In some embodiments, the processor infers a vector representation of the interaction characteristic parameter of the object based on a vector representation of the aligned interaction information. A specific description of the part may be found in the corresponding content of FIG. 6.

In 550, multi-modal information fusion and representation may be performed on the semantic feature information, the operating environment of the intelligent agent, and the interaction characteristic parameter to obtain multi-dimensional environment information. More details regarding the multi-modal information fusion and the multi-dimensional environment information may be found in other contents of the present disclosure (e.g., descriptions in connection with FIG. 3).

The multi-modal information fusion includes, but is not limited to, weighted fusion, feature concatenation, attention mechanisms, neural network fusion, or the like.

In some embodiments, when the weighted fusion is used for the multi-modal information fusion and representation, weights of the semantic feature information, the operating environment of the intelligent agent, and the interaction characteristic parameter are related to respective priority weights. For example, the weights are equal to the respective priority weights.

In some embodiments, the processor determines a priority weight of the semantic feature information according to a degree of association between the semantic feature information and a planning task step, determines a priority weight of the operating environment of the intelligent agent according to a clarity of the two-dimensional image and a data point validity rate of the depth, and determines a priority weight of the interaction characteristic parameter according to an inference confidence of the interaction characteristic parameter and a time step of the predictability judgment. More details regarding the planning task step may be found in other contents of the present disclosure (e.g., descriptions in connection with FIG. 4). More details regarding the depth may be found in other contents of the present disclosure (e.g., descriptions in connection with FIG. 2).

The degree of association refers to a degree of correlation between category information of the object and an operation action in the planning task step. For example, if the planning task step is to put tea leaves into a teacup and the object is the tea leaves, the degree of association is high. If the object is a non-operating region, such as a background wall, the degree of association is low.

In some embodiments, the processor determines the degree of association between the semantic feature information and the planning task step in a plurality of ways. For example, the processor determines the degree of association by querying a preset association table based on the semantic feature information and the planning task step. The preset association table includes the semantic feature information, the planning task step, and the degree of association between the semantic feature information and the planning task step. The preset association table is constructed based on historical data.

In some embodiments, the priority weight of the semantic feature information is positively correlated with the degree of association. That is, a higher degree of association corresponds to a larger priority weight of the semantic feature information.

The clarity of the two-dimensional image refers to a comprehensive measure of image quality indicators in a specific region, including edge contrast, local gradient intensity, texture distribution, etc. A higher clarity enables the two-dimensional image to more accurately provide object boundary and structure information. In some embodiments, the clarity is obtained by a Laplacian operator, a Brenner gradient function, etc.

The data point validity rate of the depth refers to a ratio of a count of non-empty and available data points in a depth map to a total count of pixels within a perception field of view. The data point validity rate reflects coverage completeness of depth information. A higher data point validity rate indicates more accurate spatial modeling. In some embodiments, when obtaining the depth, the processor may construct the depth map, count the total count of pixels in the depth map, identify and count valid points, determine a ratio of the count of the valid points to the total count of pixels, and use the ratio as the data point validity rate. Each pixel value in the depth map represents a distance from a corresponding point to a camera.

In some embodiments, the processor determines the priority weight of the operating environment of the intelligent agent in a plurality of ways based on the clarity of the two-dimensional image and the data point validity rate of the depth. For example, the processor performs a weighted summation on the clarity of the two-dimensional image and the data point validity rate of the depth based on a preset weight to obtain a quality score of the operating environment of the intelligent agent, and determines the priority weight of the operating environment of the intelligent agent based on the quality score. The preset weight is set based on experience. The priority weight of the operating environment of the intelligent agent is positively correlated with the quality score.

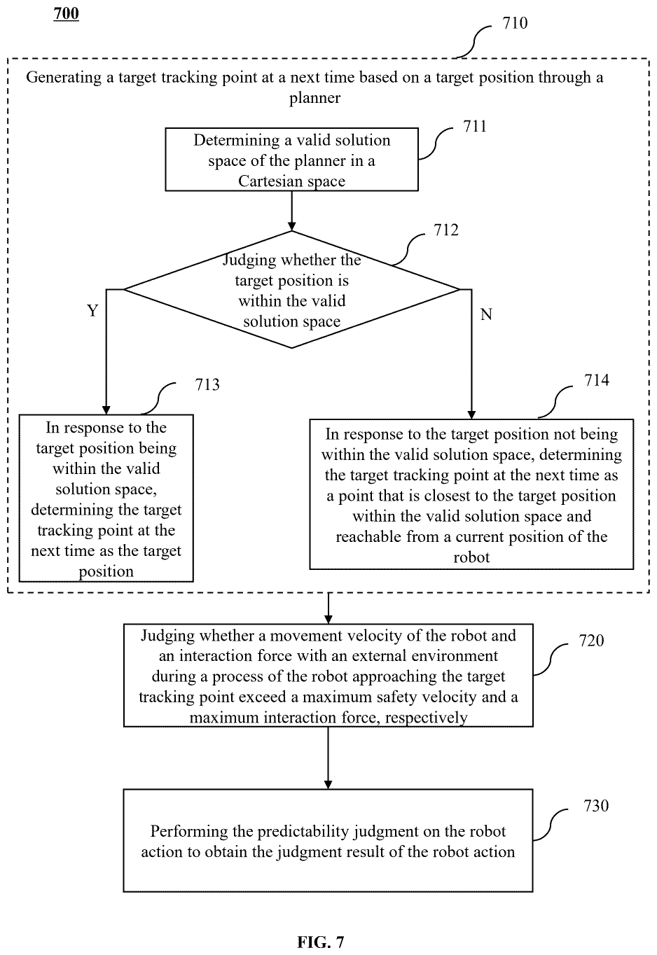

The predictability judgment refers to judging whether a current action is within a controllable range during execution of an interaction task by the robot. For example, the predictability judgment includes judging whether a current velocity and an interaction force are within a range of a maximum safety velocity and a range of a maximum interaction force. The maximum safety velocity refers to a maximum movement velocity allowed for an end effector of the robot when approaching the object. For example, the maximum safety velocity is 1 m/s, 2 m/s, etc. The maximum interaction force refers to a peak value of a force that the end effector is allowed to apply when executing a second interaction action. The maximum safety velocity and the maximum interaction force may be determined in a plurality of ways, for example, set based on experience, etc. More details regarding the maximum safety velocity and the maximum interaction force may be found in other contents of the present disclosure (e.g., descriptions in connection with FIG. 7).

The inference confidence refers to a reliability metric value of the interaction characteristic parameter inferred during a process of inferring the interaction characteristic parameter based on the embodied interaction perception signal. In some embodiments, while inferring the interaction characteristic parameter, the processor may determine indicators such as a fitting residual, a parameter estimation fluctuation range, a temporal consistency, etc., then normalize the aforementioned indicators, perform a weighted summation on the normalized indicators based on preset weights, and use a weighted sum as the inference confidence. The fitting residual refers to a difference between observed real data and data predicted based on the inferred parameter. The parameter estimation fluctuation range refers to stability and a fluctuation degree of an estimated parameter value itself within a short time. The temporal consistency refers to checking whether the estimated parameter conforms to physical laws or common-sense constraints in a time sequence.

The time step refers to a time interval between two consecutive predictability judgments. A shorter time step results in a higher judgment frequency and a more agile response. A longer time step results in a computational burden but causes a response lag. The time step may be set based on historical data.

In some embodiments, the processor may determine the priority weight of the interaction characteristic parameter in a plurality of ways based on the inference confidence of the interaction characteristic parameter and the time step of the predictability judgment. For example, the processor may set the priority weight of the interaction characteristic parameter to be positively correlated with both the inference confidence and the time step.

By introducing a priority mechanism, multi-modal information fusion becomes more task-adaptive, which dynamically enhances a contribution of a key perception channel and suppresses interference from unreliable information. Without increasing complexity of a system process, the robot can focus on key constraints at different stages of a task, which effectively improves accuracy of the multi-dimensional environment information and stability of action planning.

In 560, the predictability judgment may be performed on a robot action based on the embodied interaction perception signal.

The robot action refers to a plurality of purposeful and planned physical operations or behavior sequences executed by the robot to complete a task.

In some embodiments, the processor may judge whether a movement velocity of the robot and an interaction force with an external environment exceed the maximum safety velocity and the maximum interaction force, and perform the predictability judgment on the robot action based on a result of the judgment. More details regarding the part may be found in the corresponding description in FIG. 7.

In 570, in response to a judgment result being within an expectation, a plurality of first interaction actions may be generated based on the multi-dimensional environment information and the planning task step, and the plurality of first interaction actions may be transmitted to the robot for execution.

The judgment result being within the expectation means that an output of the predictability judgment indicates that an actual movement state of the robot and the interaction characteristic parameter are highly consistent with a predicted behavior. The predicted behavior refers to a task that the robot is predicted to accomplish.

More details regarding the first interaction actions may be found in other contents of the present disclosure (e.g., descriptions in connection with FIG. 4).

In some embodiments, the processor may generate the plurality of first interaction actions in a plurality of ways based on the multi-dimensional environment information and the planning task step.

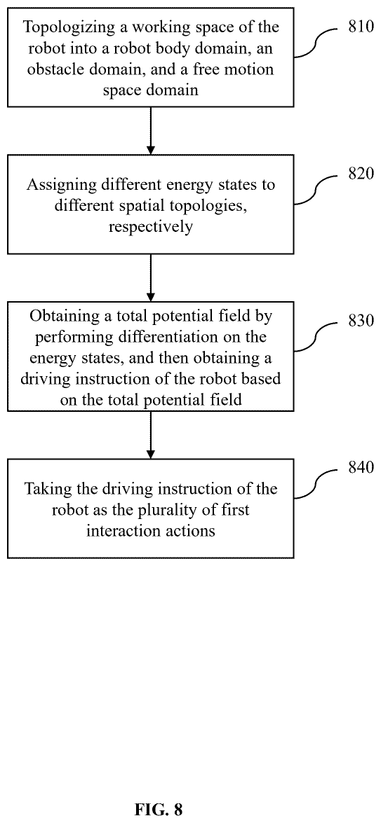

In some embodiments, the processor may generate the plurality of first interaction actions based on an energy gradient manner. More details regarding the part may be found in the corresponding description in FIG. 8.

In some embodiments, the processor may determine a pose trajectory of the end effector and a joint torque of the robot according to the planning task step, control joint motors of the robot to drive a plurality of joints to rotate according to the joint torque, and control the end effector of the robot to complete a gripping or pushing operation according to the pose trajectory. More details regarding the end effector may be found in other contents of the present disclosure (e.g., descriptions in connection with FIG. 2).

The pose includes a position and an orientation of the end effector. The position refers to a coordinate of the end effector in a three-dimensional space. The orientation refers to a pointing direction of the end effector in the three-dimensional space. The pose trajectory refers to a desired movement trajectory of the end effector in the three-dimensional space, includes positions and orientations of the end effector at a plurality of time points, and is used to accurately execute an operation task.

The joint torque refers to a driving torque required to be applied to control each joint of the robot.

In some embodiments, the pose trajectory may be generated by a planner. After determining the pose trajectory, the processor may derive the joint torque required to be applied to the plurality of joints based on the pose trajectory through a preset manner. The preset manner includes an inverse dynamics algorithm, a dynamics model, etc.

The joint motors refer to electric motors installed on each joint of the robot. In some embodiments, the joint motors receive an instruction related to the joint torque from an action generation unit, and adjust a driving current of each of the joint motors to generate a target joint torque in combination with a current pose of the end effector, thereby causing a corresponding joint to rotate according to a target pose. The target joint torque refers to a joint torque required for each joint of the robot to achieve rotation at a next time point. The target pose refers to a pose that the end effector needs to achieve at the next time point in the pose trajectory.

The gripping operation refers to an operation of grabbing and fixing the object using a tool such as a gripper. The pushing operation refers to an operation of applying a force to the object to cause the object to move.

In some embodiments, the processor may convert the pose trajectory of the end effector into a control instruction, and drive the end effector to move in space according to a set pose trajectory. When performing the gripping operation, the end effector approaches the object under guidance of the pose trajectory, and triggers the gripper to close at a preset time to complete the gripping operation. When performing the pushing operation, the end effector maintains contact with the object and moves along the set pose trajectory after establishing contact to complete a pushing process.

Combining pose trajectory planning with joint torque control refines actions that the robot needs to execute, enhancing the flexibility and accuracy of the action execution of the robot, which enables the robot to perceive the environment, make intelligent decisions, and achieve dexterous manipulation.

In 580, in response to the judgment result being outside the expectation, a plurality of second interaction actions may be generated based on the interaction characteristic parameter, and the plurality of second interaction actions may be transmitted to the robot for execution. More details regarding the second interaction actions may be found in other contents of the present disclosure (e.g., descriptions in connection with FIG. 4).

The judgment result being outside the expectation means that the output of the predictability judgment detects that a current actual state of the robot and the interaction characteristic parameter have a significant deviation from the predicted behavior, necessitating a change in the interaction action

In some embodiments, the plurality of second interaction actions have an interaction force characteristic. More details regarding the interaction force characteristic may be found in other contents of the present disclosure (e.g., descriptions in connection with FIG. 4).

The processor may generate the plurality of second interaction actions in a plurality of ways based on the interaction characteristic parameter.

In some embodiments, the processor may determine an acting force corresponding to the plurality of second interaction actions based on the maximum interaction force, an interaction variation frequency, and a count of sampling.

The interaction variation frequency refers to a speed at which the acting force changes over time. In some embodiments, the interaction variation frequency is a fixed value of π/100.

The count of sampling refers to a total count of times that an acting force on the end effector is sampled during execution of an entire action. In some embodiments, the count of sampling does not exceed 100 times. For example, the count of sampling is 50 times, 70 times, etc.

In some embodiments, the maximum interaction force, the interaction variation frequency, and the count of sampling are obtained in a plurality of ways, e.g., set based on experience.

The acting force corresponding to the plurality of second interaction actions refers to a force that the end effector needs to apply to act on the object. In some embodiments, the acting force varies according to a pattern of a sine function, i.e., the acting force varies periodically within a range of the maximum interaction force.

In some embodiments, in response to an action being within an unpredictable range, the processor generates the plurality of second interaction actions based on the maximum interaction force, the interaction variation frequency, and the count of sampling by using an energy gradient manner, including: applying a plurality of force stimuli to an obstacle and observing a special form thereof, thereby obtaining a sufficient perception data set ψ(t)=[Δx,\dot{x},F]. An input of active perception is an acting force F_{act}, and an interaction force variation characteristic thereof is determined by the sine function, specifically as shown in the following formula:

$${F}_{act} = {F}_{s a f e} sin ( ω t ) , t ∈ ( 0 , 100 ] , \qquad ( 2 )$$

wherein F_{act} denotes the interaction force, F_{safe} denotes the maximum interaction force, ω=π/100 denotes the interaction variation frequency, and t denotes the count of sampling.

By periodically determining the acting force, an autonomous response capability of the robot in an abnormal situation is enhanced.

In some embodiments, the processor queries a vector database based on the interaction characteristic parameter to determine an amplitude, a frequency, and a count of sampling of a sinusoidal interaction excitation, controls the end effector of the robot to apply a periodic disturbance to the object based on the sinusoidal interaction excitation, and controls the perception device to monitor response data of the periodic disturbance.

The sinusoidal interaction excitation refers to a force or position disturbance that is actively emitted by the robot and varies according to the pattern of the sine function. The amplitude refers to a magnitude of a strength or a range of the disturbance. The frequency refers to a speed of the disturbance. The count of sampling refers to a duration of the disturbance.

Exemplarily, the sinusoidal interaction excitation is represented by the following formula:

$$F ( t ) = Asin ( ω t ) , \qquad ( 3 )$$

wherein A denotes the amplitude, w denotes the frequency, and t denotes the count of sampling of the sinusoidal interaction excitation.

It is understandable that when A=F_{safe} and ω=π/100, the sinusoidal interaction excitation is the aforementioned interaction force.

The vector database includes a plurality of reference vectors, and a reference maximum interaction force, a reference interaction variation frequency, and a reference count of sampling corresponding to each of the plurality of reference vectors. In some embodiments, the processor selects historical interaction records with high excitation effects and coverage of different object types, for each historical interaction record, constructs a reference vector based on the interaction characteristic parameter collected therefrom, and uses the maximum interaction force, the interaction variation frequency, and the count of sampling corresponding to the reference vector as the reference maximum interaction force, the reference interaction variation frequency, and the reference count of sampling. The high excitation effects mean that a historical sinusoidal interaction excitation effectively excites an object response on a corresponding interaction object, and does not cause force over-limit, contact instability, or false touch triggering an emergency stop. Effectively exciting the object response means that the object produces an identifiable structural micro-displacement, vibration, or temperature change. The coverage of different object types means that the selected historical interaction records include a plurality of typical interaction objects and mechanical response features thereof, e.g., a rigid body (such as a metal part), a flexible body (such as foam plastic), a high-damping body (such as a rubber part), a fragile body (such as glass/ceramic), etc. More details regarding obtaining the vector representation of the interaction characteristic parameter may be found in other contents of the present disclosure (e.g., descriptions in connection with FIG. 6).

In some embodiments, the processor generates a query vector based on a current interaction characteristic parameter, inputs the query vector into the vector database, determines vector similarities between the query vector and the plurality of reference vectors, selects a reference vector with a highest similarity to the query vector, and uses the reference maximum interaction force, the reference interaction variation frequency, and the reference count of sampling corresponding to the reference vector as a current maximum interaction force, a current interaction variation frequency, and a current count of sampling. The vector similarity is represented by cosine similarity, or the like.

The periodic disturbance refers to a process that the end effector of the robot continuously executes an interaction excitation action with a specific frequency and amplitude for a certain duration, used to elicit a response on or within the object.

The response data refers to object reaction information collected by the perception device during a periodic disturbance process, e.g., displacement or vibration information of the object.

Retrieving the optimal excitation parameter combination based on the current interaction characteristic parameter enhances the effect stability and parameter adaptability of the second interaction actions, which enables adaptation to change in interaction characteristics across different materials and object types, thereby improving the adaptive capability of the robot in complex environments.

By actively applying a series of interaction force stimuli to the object, the intelligent agent observes the temporal features of interaction force-response of the object after stress through the multi-modal perception device. Based on the observation features, the intelligent agent infers an implicit interaction characteristic of the object to constrain an interaction action of the intelligent agent, improves understanding of the intelligent agent for paired temporal signals of interaction force-response, thereby improving an embodied interaction adaptation level of the intelligent agent, and improving robot action safety.

FIG. 6 is a schematic diagram illustrating a process for inferring an interaction characteristic parameter according to some embodiments of the present disclosure. In some embodiments, a processor obtains a vector representation 640 of aligned interaction information based on an interaction displacement 610, a movement velocity 620 of an observation point at an interaction interface, and an interaction force 630 at the interaction interface, and infers a vector representation 650 of an interaction characteristic parameter of an object based on the vector representation 640 of the aligned interaction information.

The interaction displacement refers to a position change of a contact point relative to a reference point.

The interaction force refers to a magnitude of a contact force between a robot and the object.

In some embodiments, the processor combines the interaction displacement 610, the movement velocity 620 of the observation point at the interaction interface, and the interaction force 630 at the interaction interface that are aligned in time into a structured data vector, as the vector representation 640 of the aligned interaction information.

In some embodiments, information aligned at the interaction interface between an intelligent agent and the object is obtained as:

$$ψ ( t ) = {[ Δ {x}_{m} , {\dot{x}}_{m} , {F}_{m} ]}^{T} , \qquad ( 4 )$$

wherein ψ(t) denotes the aligned interaction information, Δxₘ denotes the interaction displacement, \dot{x}ₘ denotes the movement velocity of the observation point at the interaction interface, and Fₘ denotes the interaction force at the interaction interface.

In some embodiments, the vector representation 640 of the interaction characteristic parameter is represented based on an elastic operation coefficient, a damping operation coefficient, and an operation loss constant of the object. For example, the vector representation 640 of the interaction characteristic parameter is represented as θ=[K,D,f]^{T}. θ denotes the interaction characteristic parameter, K denotes the elastic operation coefficient of the object, D denotes the damping operation coefficient of the object, and f denotes the operation loss constant of the object. More details regarding the elastic operation coefficient, the damping operation coefficient, and the operation loss constant of the object may be found in other contents of the present disclosure (e.g., description in connection with FIG. 1).

In some embodiments, an inference process includes: modeling an interaction characteristic of the object as a linear system, including: the interaction characteristic parameter being positively correlated with a difference between a system superposed output vector and system state noise, and negatively correlated with a system superposed information matrix, the system superposed output vector including an observed temporal input feature at the interaction interface, the system state noise including a plurality of noises, and the system superposed information matrix including an observed temporal input signal at the interaction interface; and estimating the linear system using a parameter estimation algorithm to obtain a system prediction error. When the system prediction error is minimized, an interaction characteristic parameter corresponding to the minimized system prediction error is taken as a final interaction characteristic parameter; and the final interaction characteristic parameter is obtained by performing partial differentiation on the system prediction error.

The linear system refers to a model for interaction dynamics between the robot and the object.

The system superposed output vector refers to a vector including observed temporal input features (such as displacement and velocity), as an input matrix of the linear system.

The observed temporal input signal refers to a physical quantity that is directly measured and recorded by a perception device and changes over time during an interaction process.

The observed temporal input feature refers to a quantitative index extracted or constructed from an original signal and capable of characterizing a certain characteristic of the system.

The noises refer to a sum of all unknown or unpredictable random factors that cause a difference between a model prediction value and an actual observation value.

The parameter estimation algorithm refers to an algorithm for estimating parameters of a system model from noisy data. For example, the parameter estimation algorithm includes a least squares manner, Kalman filtering, or the like.

The system prediction error refers to a difference between an output predicted using currently estimated parameters and input data, and an actually observed output.

In some embodiments, the system prediction error is a cumulative sum of squared errors. A squared error is a square of a difference between the observed temporal input feature at the interaction interface and a product of the observed temporal input signal at the interaction interface and the interaction characteristic parameter.

In some embodiments, the processor may determine the system prediction error based on the observed temporal input feature at the interaction interface, the observed temporal input signal, and the interaction characteristic parameter through a preset formula. An exemplary preset formula is as follows:

$${J}_{1} ( θ ) = {{\sum }_{j = 1}^{t} [ y ( j ) - {ψ}^{T} ( j ) θ ]}^{2} , \qquad ( 5 )$$

wherein y(j) denotes the observed temporal input feature at the interaction interface, ψ^{T}(j) denotes the observed temporal input signal at the interaction interface, J₁(θ) denotes the system prediction error, and θ denotes the interaction characteristic parameter.

The foregoing manner can make the determined system prediction error more accurate.

Merely by way of example, during an inference process, it is assumed that a projection from observed data to a parameter vector is a linear model, and parameters of the linear model are determined using a linear fitting manner. The interaction characteristic of the object is modeled as:

$$Y ( t ) = H ( t ) θ + V ( t ) , \qquad ( 6 )$$

wherein Y(t)=[y(1), y(2), . . . , y(t)]^{T}∈R^{t} denotes the system superposed output vector, H(t)=[ψ^{T}(1), ψ^{T}(2), . . . , ψ^{T}(t)]^{T}∈R^{t×3} denotes the system superposed information matrix, (t)=[v(1), v(2), . . . , v(t)]^{T}∈R^{t} denotes the system state noise, y(t) denotes the observed temporal input feature at the interaction interface, ψ^{T}(t) denotes the observed temporal input signal at the interaction interface, and v(t) denotes the noise.

Subsequently, a least squares parameter estimation algorithm is used to estimate the interaction characteristic parameter of the object, to obtain the system prediction error, as shown in the foregoing formula (5).

Assuming that J₁(θ) reaches a minimum value at θ=\hat{θ}, a partial derivative of J₁(θ) with respect to \hat{θ} is set to zero, to obtain the following formula (7):

$${\frac{\partial {J}_{1} ( θ )}{\partial θ} \vert}_{θ = \hat{θ}} = - 2 {H}_{t}^{T} ( {Y}_{t} - {H}_{t} θ ) = 0 , \qquad ( 7 )$$

wherein y(j) denotes the observed temporal input feature at the interaction interface, ψ^{T} denotes the observed temporal input signal at the interaction interface, J₁(θ) denotes the system prediction error, Hₜ denotes the system superposed information matrix, and Yₜ denotes the system superposed output vector.

Modeling the interaction characteristic of the object and then inferring the interaction characteristic parameter helps improve accuracy of the determined interaction characteristic parameter. Using the minimization of prediction error (e.g., the least squares manner) as the optimization criterion and mathematically finding the optimal solution by taking partial derivatives ensures that the parameter estimation is statistically optimal and unbiased, thereby achieving high identification accuracy.

FIG. 7 is an exemplary flowchart illustrating a process for performing a predictability judgment on a robot action according to some embodiments of the present disclosure. In some embodiments, as shown in FIG. 7, a process 700 includes the following operations. The process 700 is performed by a processor.

In 710, a target tracking point may be generated at a next time based on a target position through a planner.

The target position refers to a position and an orientation of a final point that an end effector of a robot needs to reach in a three-dimensional space. The target position may be determined in a plurality of ways before the interaction begins. For example, the target position may be obtained through manual input by an operator. As another example, the target position may be determined by the processor based on input from the operator.

The planner refers to an algorithm or a software module in the robot.

The target tracking point refers to a point that the robot needs to reach at the next time.

In some embodiments, operation 710 includes the following operations 711-714.

In 711, a valid solution space of the planner may be determined in a Cartesian space.

The valid solution space refers to a spatial range of a collision-free path that meets physical constraints of the robot. The valid solution space is determined by the planner.

In 712, whether the target position is within the valid solution space may be judged.

There are two cases: the target position is within the valid solution space, and the target position is not within the valid solution space.

In 713, in response to the target position being within the valid solution space, the target tracking point at the next time may be determined as the target position.

In 714, in response to the target position being not within the valid solution space, the target tracking point at the next time may be determined as a point that is closest to the target position within the valid solution space and reachable from a current position of the robot.

In some embodiments, when the target position is not within the valid solution space, the planner determines a boundary of the valid solution space through an optimization algorithm, and finds a point on the boundary that is closest to a desired target position, as the target tracking point at the next time.

In 720, whether a movement velocity of the robot and an interaction force with an external environment during a process of the robot approaching the target tracking point exceed a maximum safety velocity and a maximum interaction force may be judged, respectively.

The movement velocity of the robot and the interaction force with the external environment are obtained through sensors, for example, an accelerometer, a force sensor, etc.

In some embodiments, the movement velocity is obtained by integrating an acceleration of the robot approaching the target tracking point. In some embodiments, the acceleration of the robot approaching the target tracking point is determined by an inertia matrix, a driving instruction of the robot, a Coriolis matrix, and a gravity vector when a joint space velocity of the robot is a certain value.

The joint space velocity refers to an instantaneous movement velocity of each joint of the robot.

The inertia matrix refers to a matrix that describes how mass and distribution of robot links affect acceleration of the robot.

The driving instruction refers to an instruction related to a torque or a force required to drive each joint motor of the robot.

The Coriolis matrix refers to a matrix related to a joint velocity of the robot for the acting force (Coriolis force and centrifugal force).

The gravity vector refers to a vector representing a torque generated by gravity on each joint.

Merely by way of example, the planner generates the target tracking point g* at the next time based on the target position g, as shown in the following formula (8):

$$φ : g \to ε ( t )$$

$${g}^{*} = \{ \begin{matrix}{arg min}_{x ∈ ε ( x )} d ( x , g ) if g ∉ ε ( x ) \\ g if g ∈ ε ( x )\end{matrix} , \qquad ( 8 )$$

wherein ε(x) denotes the valid solution space of the planner in the Cartesian space, x denotes the current position of the robot, g* denotes the target tracking point, and g denotes the target position.

The processor determines whether the movement velocity of the robot and the interaction force with the external environment obtained based on an embodied interaction perception signal during the process of the robot approaching the target tracking point exceed the maximum safety velocity V_{safe} and the maximum interaction force F_{safe}, respectively. Operations of determining the interaction force include: determining an acceleration \ddot{x} of the robot as the robot approaches the target tracking point:

$$\ddot{x} = {M ( q )}^{- 1} ( {F}^{*} - C ( q , \dot{q} ) \dot{x} - G ( q ) ) , \qquad ( 9 )$$

wherein \ddot{x} denotes the acceleration, M and C denote the inertia matrix and the Coriolis matrix, respectively, q denotes the joint space velocity of the robot, G denotes the gravity vector, F* denotes the driving instruction of the robot, and \dot{x} denotes the movement velocity of the robot.

The movement velocity of the robot as the robot approaches the target tracking point is determined by the following formula (10):

$$\dot{x} = \int \ddot{x} dt . \qquad ( 10 )$$

The interaction force is determined by the following formula (11):

$$F = f + K Δ x + D \dot{x} , \qquad ( 11 )$$

wherein F denotes the interaction force, K denotes an elastic operation coefficient of an object, D denotes a damping operation coefficient of the object, and f denotes an operation loss constant of the object.

The elastic operation coefficient refers to data related to an ability of the object to resist deformation. The damping operation coefficient refers to data related to a characteristic of energy dissipation during movement of an object. The operation loss constant represents a constant resistance opposite to a direction of velocity.

In some embodiments, the processor dynamically sets the maximum interaction force and the maximum safety velocity according to semantic feature information and an interaction characteristic parameter.

In some embodiments, the processor first queries a preset table based on the semantic feature information of the object to determine a basic interaction limit standard (i.e., to determine basic values of V_{safe} and F_{safe}), and then further modifies the basic interaction limit standard by combining a current interaction characteristic parameter, such as the elastic operation coefficient K of the object, the damping operation coefficient D of the object, and the operation loss constant f of the object. The further modification is performed based on the following principles: 1) F_{safe} is positively correlated with K, i.e., a harder object may generally withstand a greater force; 2) V_{safe} is positively correlated with D, i.e., an object with greater damping may better absorb impact, allowing a slightly faster approach velocity; 3) V_{safe} is negatively correlated with K, i.e., when interacting with a harder object, an approach velocity is slower to prevent collision. The preset table refers to a table including a correspondence between the semantic feature information and the basic values of V_{safe} and F_{safe}. The preset table is constructed based on historical data.

By introducing a dynamic adjustment mechanism for force and velocity limits driven by semantic features and the interaction characteristic parameter, interaction thresholds can be adaptively set according to different object characteristics, significantly enhancing the interaction safety and task adaptability of the robot in complex object environments.

In 730, the predictability judgment may be performed on the robot action to obtain a judgment result of the robot action.

In some embodiments, in response to the interaction force exceeding the maximum interaction force or the movement velocity exceeding the maximum safety velocity, the processor determines the judgment result as a dangerous action, and in response to the interaction force not exceeding the maximum interaction force and the movement velocity not exceeding the maximum safety velocity, determines the judgment result as a safe action. The safe action is within an expectation.

Merely by way of example, a judgment result of a robot action a is represented by the following formula (12):

$$a = \{ \begin{matrix}F \geq {F}_{safe} or V \geq {V}_{safe} {a}_{d} \\ else {a}_{s}\end{matrix} , \qquad ( 12 )$$

wherein F denotes the interaction force, F_{safe} denotes the maximum interaction force, V denotes the movement velocity, V_{safe} denotes the maximum safety velocity, aₛ denotes the safe action, and a_{d} denotes the dangerous action.

Based on the maximum interaction force and the maximum safety velocity, the judgment result can be determined more accurate, which is beneficial for subsequent adaptive adjustment of the robot.

In some embodiments, the processor dynamically adjusts a time step of the predictability judgment based on a current velocity of the robot, the acceleration, and a distance between the robot and the target tracking point.

The time step refers to an execution cycle of the predictability judgment. A shorter time step results in a higher judgment frequency and a more agile response. A longer time step reduces computational burden but causes response lag.

In some embodiments, the processor monitors a current velocity and an acceleration of the end effector of the robot in real time and determines a distance between the end effector and the target tracking point. When the robot moves rapidly or approaches the target tracking point, indicating increased interaction risks, the time step is automatically shortened to increase a system response frequency. When the robot remains stable or is far from the target tracking point, the time step is extended to reduce computational load, ensuring both real-time and efficient decision-making.

Dynamically adjusting the execution frequency of the predictability judgment based on the current state of the robot enables rapid responses during high-speed or high-risk operations while reducing resource consumption in low-risk phases, which enhances the timeliness and efficiency of the judgment mechanism, improving the stability and flexibility of the overall interaction process.

Determining the valid solution space effectively prevents the robot from forcibly extending to a limit position, which causes jamming, loss of control, or damage. Setting the maximum interaction force and the maximum safety velocity fundamentally prevents the robot from losing control due to excessive velocity or having excessive energy upon impact. And the predictability judgment improves an intelligence level of robot movement.

FIG. 8 is an exemplary flowchart illustrating a process for generating a plurality of first interaction actions according to some embodiments of the present disclosure. In some embodiments, as shown in FIG. 8, a process 800 includes the following operations. The process 800 is executed by a processor.

In 810, a working space of a robot may be topologized into a robot body domain, an obstacle domain, and a free motion space domain.

The working space refers to a set of all spatial points reachable by an end effector of the robot.

The robot body domain is a space occupied by all components of the robot itself, such as links and joints, in a current pose.

In some embodiments, the robot body domain is determined based on a pose of the robot and a robot spatial configuration in the current pose.

The robot spatial configuration refers to a bending or extension state of all current joints of the robot when the pose is determined.

The obstacle domain refers to a space occupied by all obstacles in the working space. The obstacle domain includes moving obstacles (e.g., other robots) and fixed obstacles. It is understandable that a portion of the space in the obstacle domain is reachable by the robot.

The free motion space domain refers to all space in the working space not occupied by obstacles. The free motion space domain does not include the portion of the space in the obstacle domain that is reachable by the robot.

In some embodiments, when an action is within an expected range, generating a plurality of interaction actions with an interaction force characteristic by an energy gradient manner based on an interaction characteristic parameter includes: first topologizing the working space of the robot into a robot body domain X(t):=(x̅(t),(r,h)), an obstacle domain O(t):={x∈W|Xₒ(t)∪Xᵣ(t)}, and a free motion space domain F(t):={x∈W|C_{W}Xᵣ(t)\O(t)}. x̅(t) denotes the pose of the robot, r and h denote the robot spatial configuration in the current pose, x denotes a current position of the robot, W denotes the working space of the robot, Xₒ(t) denotes a fixed obstacle domain, Xᵣ(t) denotes the robot body domain, and C_{W} denotes a difference set between the working space and the obstacle domain and the robot body domain. In 820, different energy states may be assigned to different spatial topologies.

The energy states refer to abstract energy values assigned to each spatial domain.

In some embodiments, the robot body domain is assigned as a virtual energy potential field having elastic attraction, the free motion space domain is assigned as a damping field having a linear characteristic, and the obstacle domain is assigned as a work domain having an energy operation cost.

The virtual energy potential field having the elastic attraction refers to a virtual environment defined by a mathematical formula that produces an effect similar to a spring pulling force, ensuring that the robot is continuously attracted toward a target.

The damping field having the linear characteristic refers to a resistance opposite to a direction of velocity and proportional to the velocity.

The energy operation cost refers to a numerical value that quantifies a cost that the robot needs to pay to approach or resist an obstacle.

The work domain refers to a region that requires energy consumption (work) to enter.

In some embodiments, different energy states are assigned to different spatial topologies, respectively. The robot body domain is assigned as a virtual energy potential field U_{g}(x) having the elastic attraction, the free motion space domain is defined as a damping field U_{f}(x) having the linear characteristic, and the obstacle domain is defined as a work domain U_{o,d}(x)=W(θ,x) having the energy operation cost.

In some embodiments, the energy states are energy states of the robot at the current position, specifically obtained by summing the virtual energy potential field, the damping field, and work domains of all obstacles in the obstacle domain.

Merely by way of example, an energy state of the robot at a spatial position x may be represented by the following formula (13):

$$U ( x ) = {U}_{g} ( x ) + {U}_{f} ( x ) + \sum {U}_{o} ( x ) , \qquad ( 13 )$$

wherein Uₒ(x) denotes a set of U_{o,d}(x).

Comprehensively considering various environmental factors can make the determined energy state more accurate, thereby making the movement of the robot more natural.

In 830, a total potential field may be obtained by performing differentiation on the energy states, and then a driving instruction of the robot may be obtained based on the total potential field.

In some embodiments, by performing differentiation on the energy states, the driving instruction of the robot is obtained as shown in the following formula (14):

$${F}^{*} = - grad [ U ( x ) ] , \qquad ( 14 )$$

In 840, the driving instruction of the robot may be taken as a plurality of first interaction actions.

By modeling the environment through a unified virtual energy field, the complex navigation and obstacle avoidance problem is transformed into efficient potential gradient computation, enabling the robot to generate human-like motion instructions in real-time, smoothly and safely, significantly enhancing autonomy and reliability of the robot in dynamic unknown environments.

The present disclosure provides a method for planning embodied interaction of an intelligent agent based on active perception of environmental information. The method includes: S1, obtaining environmental information around the intelligent agent and information at an interaction interface between the intelligent agent and an object, the information at the interaction interface between the intelligent agent and the object being an embodied interaction perception signal, and the environmental information including a two-dimensional image and depth, extracting sampling data of a most recent time from obtained information, and aligning the sampling data to obtain aligned environmental information and aligned information at the interaction interface between the intelligent agent and the object; S2, performing object recognition and semantic segmentation on the aligned environmental information to obtain semantic feature information, and fusing the aligned environmental information to obtain an operating environment of the intelligent agent, inferring an interaction characteristic parameter based on the aligned information at the interaction interface between the intelligent agent and the object, and performing multi-modal information fusion and representation on the semantic feature information, the operating environment of the intelligent agent, and the interaction characteristic parameter to obtain multi-dimensional environment information; S3, obtaining the embodied interaction perception signal, performing a predictability judgment on a robot action based on the embodied interaction perception signal, if a judgment result is within an expectation, generating a plurality of embodied interaction actions through an energy gradient manner based on the multi-dimensional environment information and a planning task step, the plurality of first interaction actions being executed by the robot; otherwise, generating a plurality of interaction actions having an interaction force characteristic through the energy gradient manner based on the interaction characteristic parameter, the plurality of interaction actions being executed by the robot.

The present disclosure enables the intelligent agent to possess an ability to perceive physical signals at the interaction interface like a human. By applying an active interaction force stimulus to the object, the intelligent agent can observe a spatial state response of the object after stress through perception means such as electronic skin vision. An understanding of paired temporal signals of interaction force-response by the intelligent agent enables inference of implicit physical characteristics of the object. Through active acquisition of interaction characteristic information of a surrounding environment, the robot possesses an ability to anticipate the interaction actions. Based on this ability, the intelligent agent overcomes key perception and motor control challenges in unknown, complex, dense, and human-centric environments, such as unexpected collisions, limited visual perception, and unsolvable free motion spaces.

Embodiments of the present disclosure provide a non-transitory computer-readable storage medium. The storage medium stores computer instructions. When the computer instructions are executed by a processor, the processor implements a method for planning embodied interaction of an intelligent agent based on active perception of environmental information.

The preferred specific embodiments of the present disclosure have been described in detail above. It should be understood that those skilled in the art may make many modifications and changes according to the concept of the present disclosure without creative effort. Therefore, all technical solutions that may be obtained by those skilled in the art through logical analysis, reasoning, or limited experiments based on the existing technology according to the concept of the present disclosure shall fall within the protection scope defined by the claims.

1. A method for planning embodied interaction of an intelligent agent based on active perception of environmental information, comprising:
S1: obtaining environmental information around the intelligent agent for controlling robot movement and information at an interaction interface between the intelligent agent and an object, wherein the information at the interaction interface between the intelligent agent and the object is an embodied interaction perception signal, and the environmental information includes a two-dimensional image and depth; extracting sampling data of a most recent time from obtained information, and aligning the sampling data to obtain aligned environmental information and aligned information at the interaction interface between the intelligent agent and the object;
S2: performing object recognition and semantic segmentation on the aligned environmental information to obtain semantic feature information, and fusing the aligned environmental information to obtain an operating environment of the intelligent agent; inferring an interaction characteristic parameter based on the aligned information at the interaction interface between the intelligent agent and the object; and performing multi-modal information fusion and representation on the semantic feature information, the operating environment of the intelligent agent, and the interaction characteristic parameter to obtain multi-dimensional environment information; and
S3: obtaining the embodied interaction perception signal; performing a predictability judgment on a robot action based on the embodied interaction perception signal; in response to a judgment result being within an expectation, generating a plurality of first embodied interaction actions executed by a robot based on the multi-dimensional environment information and a planning task step using an energy gradient manner; otherwise, generating a plurality of second interaction actions with interactive force characteristics executed by the robot using the energy gradient manner based on the interaction characteristic parameter, wherein
the information at the interaction interface between the intelligent agent and the object includes an interaction force stimulus during an interaction process, a response displacement of the object, a temperature, and a vibration signal, and the embodied interaction perception signal is obtained based on an embodied interaction perception device; and
the performing a predictability judgment on a robot action based on the embodied interaction perception signal includes:
using a planner to generate a target tracking point g* at a next time based on a target position g:
$$φ : g \to ε ( t ) ,$$
$${g}^{*} = \{ \begin{matrix}{arg min}_{x ∈ ε ( x )} d ( x , g ) & if g ∉ ε ( x ) \\ g & if g ∈ ε ( x )\end{matrix} ,$$
wherein ε(x) denotes a valid solution space of the planner in the Cartesian space, and x denotes a current position of the robot;
determining whether a movement velocity of the robot and an interaction force with an external environment, obtained based on the embodied interaction perception signal, during a process of the robot approaching the target tracking point exceed a maximum safety velocity V_{safe} and a maximum interaction force F_{safe}, respectively; operations for determining the interaction force including:
determining an acceleration \ddot{x} of the robot as the robot approaches the target tracking point:
$$\ddot{x} = {M ( q )}^{- 1} ( {F}^{*} - C ( q , \dot{q} ) \dot{x} - G ( q ) ) ,$$
wherein M and C denote an inertia matrix and a Coriolis matrix, respectively, q denotes a joint space velocity of the robot, and G denotes a gravity vector:
obtaining the movement velocity of the robot: \dot{x}=∫\ddot{x}dt and the interaction force: F=f+KΔx+D\dot{x} as the robot approaches the target tracking point; and
performing the predictability judgment on the robot action to obtain the judgment result of the robot action a,
wherein the judgment result of the robot action a is:
$$a = \{ \begin{matrix}F \geq {F}_{safe} or V \geq {V}_{safe} {a}_{d} \\ else {a}_{s}\end{matrix} ,$$
wherein a_{d} denotes a dangerous action outside the expectation, and aₛ denotes a safe action within the expectation.

2. (canceled)

3. The method for planning embodied interaction of an intelligent agent based on active perception of environmental information of claim 1, wherein a spatial position of the embodied interaction perception device is as follows:
$${P}_{i} = {}_{i}^{w} {Tp}_{i} ,$$
wherein, pᵢ denotes a position of a Cartesian space of an i-th embodied interaction perception device relative to a parent joint, Pᵢ denotes a position of the i-th embodied interaction perception device relative to a centroid coordinate system of the robot, and ᵢ^{w}T denotes a homogeneous transformation matrix of the parent joint corresponding to the embodied interaction perception device relative to the centroid coordinate system of the robot.

4. The method for planning embodied interaction of an intelligent agent based on active perception of environmental information of claim 1, wherein the inferring an interaction characteristic parameter based on the aligned information at the interaction interface between the intelligent agent and the object, includes:
obtaining the aligned information at the interaction interface between the intelligent agent and the object as:
$$ψ ( t ) = {[ Δ {x}_{m} , {\dot{x}}_{m} , {F}_{m} ]}^{T} ,$$
wherein, Δxₘ denotes based on an interaction displacement, \dot{x}ₘ denotes a movement velocity of an observation point at the interaction interface, and Fₘ denotes an interaction force at the interaction interface;
using information obtained above to infer the interaction characteristic parameter of the object as θ=[K,D,f]^{T} wherein
during an inference process, interaction characteristics of the object are first modeled as:
$$Y ( t ) = H ( t ) θ + V ( t ) ,$$
wherein Y(t)=[y(1), y(2), . . . , y(t)]^{T}∈R^{t} denotes a system superposed output vector, H(t)=[ψ^{T}(1), ψ^{T}(2), . . . , ψ^{T}(t)]^{T}∈R^{t×3} denotes a system superposed information matrix, and V(t)=[v(1), v(2), . . . , v(t)]^{T}∈R^{t} denotes a system state noise,
subsequently, a least squares parameter estimation algorithm is used to estimate the interaction characteristic parameter of the object, yielding a system prediction error J₁(θ);
assuming that J₁(θ) reaches a minimum value at θ=\hat{θ}, a partial derivative of J₁(θ) with respect to \hat{θ} is set to zero, obtaining:
$$\frac{\partial {J}_{1} ( θ )}{\partial θ} {\vert}_{θ = \hat{θ}} = - 2 {H}_{t}^{T} ( {Y}_{t} - {H}_{t} θ ) {\vert}_{θ = \hat{θ}} = 0 ,$$
wherein y(j) denotes an observed temporal input feature at the interaction interface, v(t) denotes a noise, ψ^{T} denotes an observed temporal input signal at the interaction interface, J₁(θ) denotes the system prediction error, K denotes an elastic operation coefficient of the object, D denotes a damping operation coefficient of the object, and f denotes an operation loss constant of the object.

5-7. (canceled)

8. The method for planning embodied interaction of an intelligent agent based on active perception of environmental information of claim 1, wherein a system prediction error is:
$${J}_{1} ( θ ) = {\sum }_{j = 1}^{t} {[ y ( j ) - {ψ}^{T} ( j ) θ ]}^{2} ,$$
wherein y(j) denotes an observed temporal input feature at the interaction interface, v(t) denotes a noise, ψ^{T} denotes an observed temporal input signal at the interaction interface, and J₁(θ) denotes the system prediction error.

9-10. (canceled)

11. The method for planning embodied interaction of an intelligent agent based on active perception of environmental information of claim 1, wherein the generating a plurality of first embodied interaction actions executed by a robot using an energy gradient manner, includes:
first topologizing a working space of the robot into a robot body domain Xᵣ(t):=(x̅(t),(r,h)), an obstacle domain O(t):={x∈W|Xₒ(t)∪Xᵣ(t)}, and a free motion space domain F(t):={x∈W|C_{W}Xᵣ(t)\O(t)}, wherein x̅(t) denotes a pose of the robot, r and h denote a robot spatial configuration in a current pose, x denotes a current position of the robot, W denotes the working space of the robot, Xₒ(t) denotes an obstacle domain, Xᵣ(t) denotes a robot body domain, and C_{W} denotes a difference set between the working space and the obstacle domain and the robot body domain;
assigning different energy states to different spatial topologies, respectively, wherein the robot body domain is assigned as a virtual energy potential field U_{g}(x) having an elastic attraction, the free motion space domain is assigned as a damping field U_{f}(x) having a linear characteristic, and the obstacle domain is assigned as a work domain U_{o,d}(x)=W(θ,x) having an energy operation cost;
obtaining a driving instruction of the robot by performing differentiation on the energy states:
$${F}^{*} = - grad [ U ( x ) ] ,$$
the driving instruction of the robot being the plurality of first embodied interaction actions.

12. The method for planning embodied interaction of an intelligent agent based on active perception of environmental information of claim 11, wherein the energy states are energy states of the robot at the spatial position x and are as follows:
$$U ( x ) = {U}_{g} ( x ) + {U}_{f} ( x ) + \sum {U}_{o} ( x ) ,$$
wherein Uₒ(x) denotes a set of U_{o,d}(x).

13. (canceled)

14. The method for planning embodied interaction of an intelligent agent based on active perception of environmental information of claim 1, wherein the generating a plurality of second interaction actions with interactive force characteristics using the energy gradient manner based on the interaction characteristic parameter, includes:
determining an acting force corresponding to the plurality of second interaction actions by a sinusoidal function:
$${F}_{act} = {F}_{safe} sin ( ω t ) , t ∈ ( 0 , 100 ] ,$$
wherein ω=π/100 denotes an interaction variation frequency, and t denotes a count of sampling.

15-17. (canceled)
